(19) United States
(12) Patent Application Publication
(10) Pub. No.: US 2024/0348416 A1
(43) Pub. Date: Oct. 17, 2024

(54) COMMUNICATION APPARATUS AND COMMUNICATION SYSTEM

(71) Applicant: Sony Semiconductor Solutions Corporation, Kanagawa (JP)

(72) Inventors: Toshihisa Hyakudai, San Diego, CA (US); Junya Yamada, Kanagawa (JP); Satoshi Ota, Kanagawa (JP)

(21) Appl. No.: 18/681,665

(22) PCT Filed: Sep. 21, 2022
(86) PCT No.: PCT/JP2022/035156

§ 371 Date: Feb. 6, 2024

Related U.S. Application Data
(63) Continuation of application No. 17/933,644, filed on Sep. 20, 2022.
(60) Provisional application No. 63/246,507, filed on Sep. 21, 2021.

(51) Int. Cl. H04L 5/14; H04L 7/00

(52) U.S. Cl. CPC H04L 5/1469; H04L 7/0041

(57) ABSTRACT

[Problem]

To suppress EMI noise in serial transmission using a plurality of transmission cables.

[Means of Solution] A communication device includes a plurality of communication units that, by a time division duplex (TDD) communication method, transmit a plurality of first signals at staggered times to a plurality of cables, respectively and receive a plurality of second signals at staggered times by the plurality of cables, respectively.

### TECHNICAL FIELD

The present disclosure relates to a communication device and a communication system.

### BACKGROUND ART

A technique for performing high-speed serial communication via transmission cables connected between a plurality of devices has been proposed (PTL 1). This type of high-speed serial communication is used in various fields, for example, for communication between in-vehicle devices.

### CITATION LIST

### Patent Literature

### [PTL 1]

JP 2011-239011A

### SUMMARY

### Technical Problem

The transmission capacity that can be transmitted using a single transmission cable is limited, and for serial transmission of a large amount of data at high speed, it is necessary to simultaneously transmit a plurality of pieces of serial data using a plurality of transmission cables.

However, when the logic of signals on a plurality of transmission cables changes simultaneously, electro magnetic interference (EMI) noise may occur.

Therefore, the present disclosure provides a communication device and a communication system that can suppress EMI noise in serial transmission using a plurality of transmission cables.

### Solution to Problem

In order to solve the above problem, according to the present disclosure, a communication device is provided, including a plurality of communication units that, by a time division duplex (TDD) communication method, transmit a plurality of first signals at staggered times to a plurality of cables, respectively, and receive a plurality of second signals at staggered times by the plurality of cables, respectively.

The plurality of communication units may transmit the plurality of first signals to the plurality of cables at different timings, respectively, and receive the plurality of second signals from the plurality of cables at different timings, respectively.

Each of the plurality of communication units may transmit the corresponding first signal in a first signal section, and receive the corresponding second signal in a second signal section, by using the corresponding cable.

The plurality of communication units may sequentially transmit the plurality of first signals so as to be staggered by predetermined time differences to the plurality of cables.

The predetermined time differences may be equal.

The predetermined time differences may include two or more time differences each having a different time length.

A plurality of temporary storage units may be included that adjust variations in timings of receiving the plurality of second signals received by the plurality of communication units.

Each of the plurality of temporary storage units may have a storage capacity that varies depending on a signal propagation delay time of the corresponding cable.

The plurality of temporary storage units may adjust variations in signal propagation delay times of the plurality of cables.

A measurement unit may be included that measures signal propagation delay times of the plurality of cables, and the plurality of communication units may adjust, based on measurement results of the measurement unit, timings of transmitting the plurality of first signals to be transmitted to the plurality of cables.

A precision time base (PTB) counter may be included that generates time stamp information commonly used with a communication partner device, and the measurement unit may measure signal propagation delay times of the plurality of cables in synchronization with the time stamp information.

The plurality of communication units may transmit, based on measurement results of the measurement unit, to a cable with a longer signal propagation delay time of the plurality of cables, the corresponding first signal at an earlier timing.

According to the present disclosure, a communication device is provided, including a plurality of communication units that, by a time division duplex (TDD) communication method, transmit a plurality of first signals to a plurality of cables and receive a plurality of second signals by the plurality of cables, wherein the plurality of communication units include a plurality of scramblers that generate the plurality of first signals in which a plurality of transmission signals each have a logic changing at a randomized timing, and
each of the plurality of scramblers includes
a first initial value setting unit that sets a different first initial value for each of the first signals,
a first random number generation unit that generates a first pseudo-random number based on the first initial value, and
a first logical operation unit that generates the corresponding first signal by performing a logical operation between the corresponding transmission signal and the corresponding first pseudo-random number.

The first initial value setting unit may set the first initial value that is same as an initial value used by a communication partner device that receives the corresponding first signal to restore an original transmission signal.

The plurality of communication units may include a plurality of de-scramblers that perform decoding processing on the plurality of second signals, and
each of the plurality of de-scramblers may include
a second initial value setting unit that sets a different second initial value for each of the second signals,
a second random number generation unit that generates a second pseudo-random number based on the second initial value, and
a second logical operation unit that generates a corresponding reception signal by performing a logical operation between the corresponding second signal and the corresponding second pseudo-random number.

The second initial value setting unit may set the second initial value that is same as an initial value used by a communication partner device that transmits the corresponding second signal to generate the second signal.

According to the present disclosure, a communication system is provided, including:
a first communication device; and
a second communication device, the second communication device and the first communication device alternately transmitting and receiving information within a period allocated by a time division duplex (TDD) communication method,
wherein each of the first communication device and the second communication device includes
a plurality of communication units that transmit a plurality of first signals at staggered times to a plurality of cables, respectively, and receive a plurality of second signals at staggered times by the plurality of cables, respectively.

### BRIEF DESCRIPTION OF DRAWINGS

FIG. 1 is a block diagram illustrating a basic configuration of communication devices and a communication system, which are compliant with the high-speed interface standard ASA.

FIG. 2 is a diagram illustrating a TDD communication method adopted in the ASA standard.

FIG. 3 is a block diagram illustrating an internal configuration of down link Txs and up link Rxs in two SerDes devices.

FIG. 4 is a block diagram illustrating an internal configuration of a scrambler in the down link Tx.

FIG. 5 is a block diagram illustrating a schematic configuration of communication devices and a communication system that perform serial transmission in parallel via four transmission cables.

FIG. 6 is a timing chart of up link signals and down link signals, which are transmitted through four transmission cables.

FIG. 7 is a timing chart illustrating an example in which the arrival times of signals are shifted at the input ends of PHY blocks.

FIG. 8 is a diagram illustrating an example of the transmission timings of up link #1 to #4 signals and down link #1 to #4 signals, which are transmitted on four lanes corresponding to four transmission cables.

FIG. 9 is a block diagram illustrating part of an internal configuration of two SerDes devices according to a second embodiment.

FIG. 10 is a timing chart illustrating an example of controlling the timings of down link signals and up link signals output from a PHY block.

FIG. 11 is a diagram illustrating the connection relationships between the SerDes devices illustrated in FIG. 5.

### DESCRIPTION OF EMBODIMENT

Embodiments of a communication device and a communication system according to the present disclosure will be described below with reference to the drawings. Hereinafter, main components of the communication device and the communication system will be mainly described, but the communication device and the communication system may have components or functions that are not illustrated or described. The following description does not exclude components or functions that are not illustrated or described.

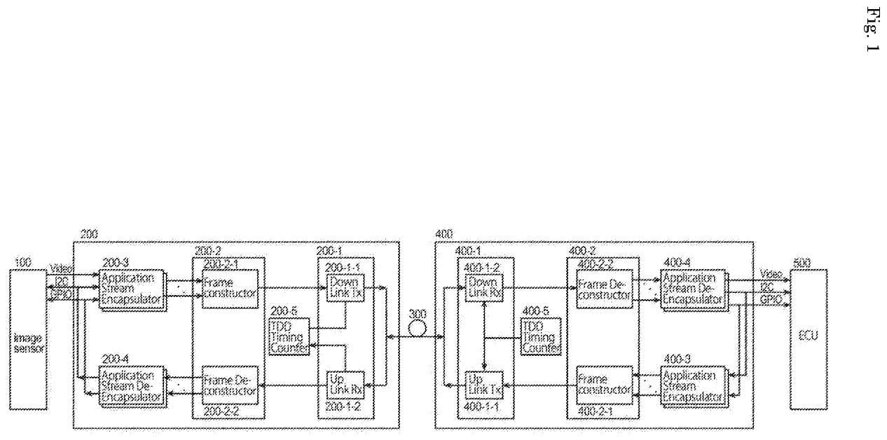

FIG. 1 is a block diagram illustrating a basic configuration of a communication device and a communication system, which are compliant with the high-speed interface standard Automotive SerDes Alliance (ASA). The communication system of FIG. 1 includes two SerDes devices (200) and (400) connected via a transmission cable. These SerDes devices correspond to communication devices according to the present disclosure.

The SerDes device (200) includes a PHY block (200-1), a link block (200-2), an application stream encapsulator (200-3), an application stream de-encapsulator (200-4), and a TDD timing counter (200-5). The PHY block (200-1) includes a down link transmitter (down link Tx, 200-1-1) and an up link Rx, 200-1-2). The link block (200-2) includes a frame constructor (200-2-1) and a frame de-constructor (200-2-2).

The SerDes device (400) includes a PHY block (400-1), a link block (400-2), an application stream encapsulator (400-3), an application stream de-encapsulator (400-4), and a TDD timing counter (400-5). The PHY block (400-1) includes an up link transmitter (up link Tx, 400-1-1) and a down link Rx, 400-1-2). The link block (400-2) includes a frame constructor (400-2-1) and a frame de-constructor (400-2-2).

An image sensor (100) is connected to the SerDes device (200), and an ECU (500) is connected to the SerDes device (400). The communication system of FIG. 1 transmits large-size video signals from the image sensor (100) at high speed from the SerDes device (200) to the SerDes device (400) via a transmission cable (300), and the ECU (500), which is connected to the SerDes device (400), performs video processing and others on the signals. In addition to video signals, control signals such as GPIO signals and I2C signals are also bidirectionally transmitted between the SerDes device (200) and the SerDes device (400) at the same time.

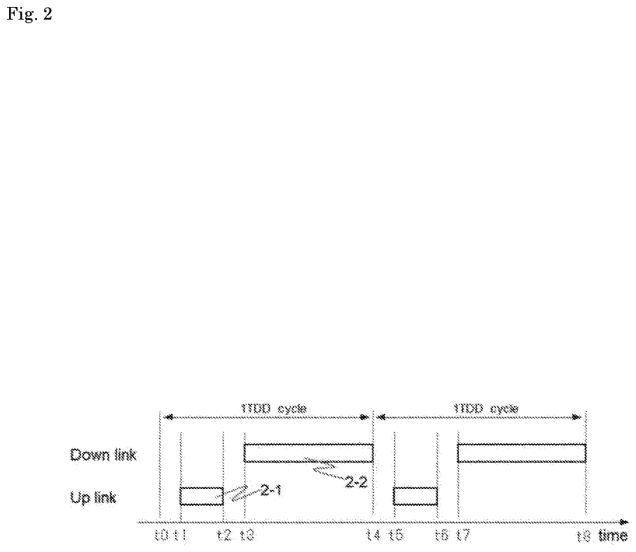

FIG. 2 is a diagram illustrating a time division multiplexing (TDD) communication method adopted in the ASA standard. As illustrated in FIG. 2, an up link signal (2-1 in FIG. 2) output from the SerDes device (400) and a down link signal (2-2 in FIG. 2) output from the SerDes device (200) are alternately transmitted through TDD communication that defines divided signal sections in advance. By adjusting the time width occupied by the down link signal (2-2 in FIG. 2) output from the SerDes device (200), a large-size video signal from the image sensor (100) can be transmitted in a time-division manner.

No-signal sections (t0 to t1, t2 to t3 in FIG. 2) are provided for switching between the up link signal (2-1 in FIG. 2) and the down link signal (2-2 in FIG. 2), making it possible to reduce the influence of propagation delays and reflections of mutual signals. The no-signal sections t0 to t1 and t2 to t3 have the same time width. As illustrated in FIG. 2, the no signal period (t0 to t1), the up link signal (t1 to t2), the no signal period (t2 to t3), and the down link signal (t3 to t4) are defined as one TDD cycle, and the TDD communication is performed by repeating the TDD cycle a plurality of times.

The timing of switching between the up link signal (2-1 in FIG. 2) and down link signal (2-2 in FIG. 2) is based on, for example, the TDD timing counter (400-5) of the SerDes device (400) illustrated in FIG. 1. By synchronizing the TDD timing counter (200-5) of the SerDes device (200) with the TDD timing counter (400-5) of the SerDes device (400), the timing of switching between the up link signal (2-1 in FIG. 2) and the down link signal (2-2 in FIG. 2) is controlled.

The TDD timing counters (400-5, 200-5) each repeatedly count one-TDD cycles (as a modulo counter for time t4). Here, the clocks counted are synchronized. The TDD timing counter (400-5) of the SerDes device (400) starts counting from time to, controls the up link Tx (400-1-1) to start output of the up link signal (2-1 in FIG. 2) at time t1, and stops the output of the up link signal at time t2. After that, the TDD timing counter (400-5) controls the down link Rx (400-1-2) from time t3 to time t4, that is, until the end of one TDD cycle, and causes processing of receiving the down link signal to be performed.

On the other hand, when the up link Rx (200-1-2) starts receiving the up link signal, the SerDes device (200) transmits information on the start to the TDD timing counter (200-5). The TDD timing counter (200-5) starts counting one TDD cycle with that time defined as t1. Until time t2, the up link Rx (200-1-2) is controlled to perform processing of receiving the up link signal. After that, the TDD timing counter (200-5) controls the down link Tx (200-1-1) to start output of the down link signal (2-2 in FIG. 2), outputs the down link signal during the time width of t3 to t4, and then stops the output. By repeating these operations, switching between the TDD signals is controlled.

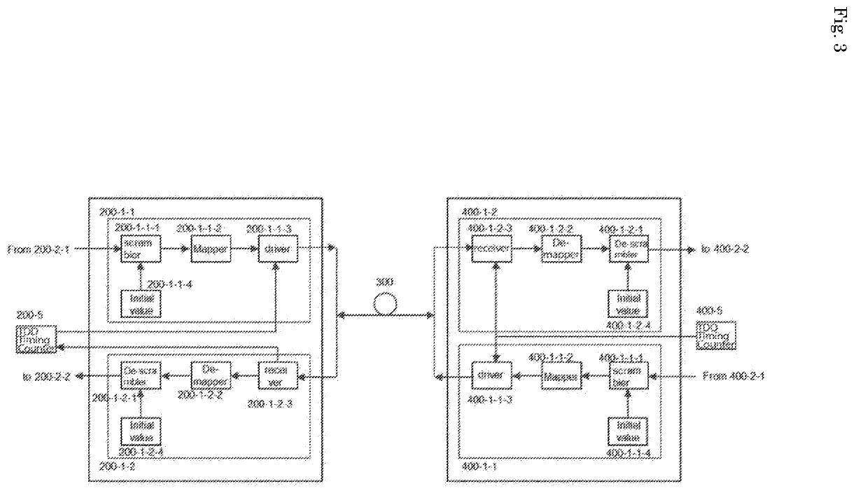

FIG. 3 is a block diagram illustrating an internal configuration of: the down link Tx (200-1-1) and the up link Rx (200-1-2) included in the PHY block (200-1) of the SerDes device (200), and the down link Rx (400-1-2) and the up link Tx (400-1-1) included in the PHY block (400-1) of the SerDes device (400), which are illustrated in FIG. 1.

The down link Tx (200-1-1) includes a scrambler (200-1-1-1), a mapper (200-1-1-2), a driver (200-1-1-3), and an initial value register (200-1-1-4). The up link Rx (200-1-2) includes a de-scrambler (200-1-2-1), a de-mapper (200-1-2-2), a receiver (200-1-2-3), and an initial value register (200-1-2-4).

The up link Tx (400-1-1) includes a scrambler (400-1-1-1), a mapper (400-1-1-2), a driver (400-1-1-3), and an initial value register (400-1-1-4). The down link Rx (400-1-2) includes a de-scrambler (400-1-2-1), a de-mapper (400-1-2-2), a receiver (400-1-2-3), and an initial value register (400-1-2-4). The above-described initial value registers (200-1-1-4, 200-1-2-4, 400-1-1-4, 400-1-2-4) each correspond to an initial value setting unit.

The internal configurations of the down link Tx (200-1-1) and the up link Tx (400-1-1) are the same. Similarly, the internal configurations of the down link Rx (400-1-2) and the up link Rx (200-1-2) are the same.

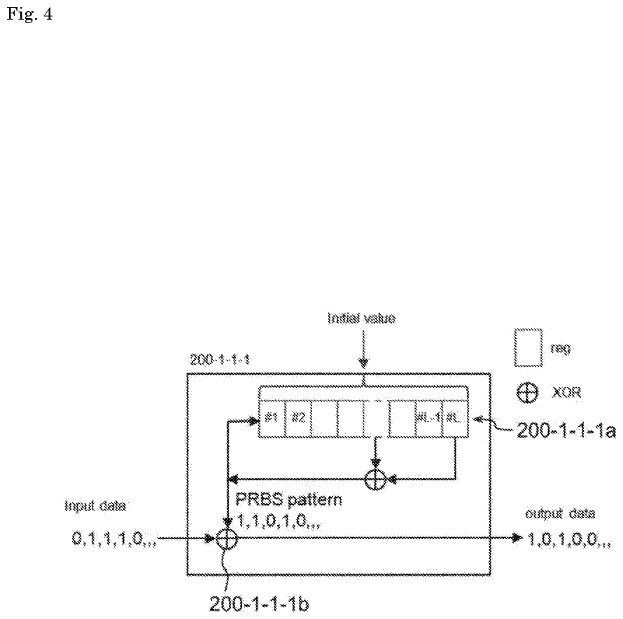

FIG. 4 is a block diagram illustrating an internal configuration of the scrambler (200-1-1-1) in the down link Tx (200-1-1). As illustrated in FIG. 4, the scrambler (200-1-1-1) includes a pseudo-random pattern generator (200-1-1-1a) and an XOR operator (200-1-1-1b). The pseudo-random pattern generator (200-1-1-1a) generates a pseudo-random number based on initial values. The XOR operator (200-1-1-1b) outputs the result of performing an XOR operation between the pseudo-random number generated by the pseudo-random pattern generator (200-1-1-1a) and input data.

The operation of the down link Tx (200-1-1) will be briefly described below. A frame-structured signal is input to the down link Tx (200-1-1) from the frame constructor (200-2-1). The scrambler (200-1-1-1) in the down link Tx (200-1-1) performs processing of eliminating bias in the frequency of occurrence of 0 and 1 by performing an XOR operation between the signal from the frame constructor (200-2-1) and a pseudo-random pattern. This makes it easier to receive data on the receiving side, and makes it possible to improve EMI characteristics by eliminating signal components with specific frequencies.

The initial values for generating a pseudo-random pattern are stored in the initial value register (200-1-1-4), and are input to the pseudo-random pattern generator in FIG. 4 at a certain timing when signal transmission starts.

The mapper (200-1-1-2) performs mapping processing on the signal output from the scrambler (200-1-1-1) according to a modulation method such as NRZ or PAM4. The mapped signal is output by the driver (200-1-1-3) to the transmission cable (300) in a predetermined signal output format. At this time, the driver (200-1-1-3) outputs the signal at an output timing controlled by the TDD timing counter (200-5) in synchronization with a predetermined one TDD cycle period.

Next, the operation of down link Rx (400-1-2) will be briefly explained. The receiver (400-1-2-3) performs processing of receiving the signals from the down link Tx (200-1) transmitted through the transmission cable (300) by equalizing transmission line distortions caused by the transmission cable length and the like and determining the data at an appropriate timing by using a clock regeneration function. The receiver (400-1-2-3) performs a receiving operation at an output timing controlled by the TDD timing counter (400-5) in synchronization with the predetermined one TDD cycle period.

The de-mapper (400-1-2-2) restores the NRZ or PAM4 signal received by the receiver (400-1-2-3) to the original digital signal. The de-scrambler (400-1-2-1) performs the same processing as the scrambler (200-1-1-1) on the signal from the de-mapper (400-1-2-2). The internal configuration of the de-scrambler (400-1-2-1) is the same as that illustrated in FIG. 4, in which an inverse operation of the operation performed on the transmitting side is performed on the pseudo-random pattern by performing an XOR operation between the pseudo-random pattern and the received signals, thereby restoring to the original data. At this time, the initial values for generating the pseudo-random pattern are stored in the initial value register (400-1-2-4), and the values are required to be the same as those stored in the initial value register (200-1-1-4) of the down link Tx (200-1-1), and the timing at which the initial values are input to the pseudo-random pattern generator is also required to be the same as in the scrambler (200-1-1-1). This is generally called scrambler synchronization processing. The output of the de-scrambler (400-1-2-1) is output to (400-2-2), which performs frame processing.

The frame de-constructor (400-2-2) extracts the packet structure for each application from the frame structure and outputs it to the corresponding application stream de-encapsulator (400-4), and each application stream de-encapsulator (400-4) decodes the output to each application signal, such as a video signal or an I2C signal, and outputs it as a predetermined signal. This is the signal flow from the SerDes device (200) to the SerDes device (400).

On the other hand, the signal flow of control signals such as I2C signals or GPIO signals from the SerDes device (400) to the SerDes device (200) is the same processing as the above-mentioned down link processing, and thus, the description thereof will be omitted.

The increased number of pixels and frame rate required for the image sensor (100) have resulted in larger size video signals. On the other hand, increasing the transmission capacity of a single transmission cable (300) is becoming increasingly difficult due to the difficulty of compensating for waveform distortion due to transmission loss caused by the length of the transmission cable. Therefore, the use of a plurality of transmission cables (300) for transmission is being put into practical use or being considered under various high-speed transmission standards.

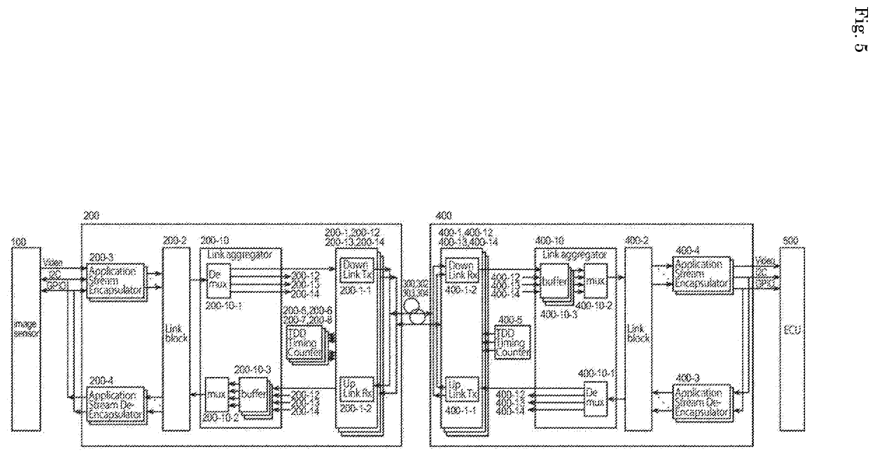

FIG. 5 is a block diagram illustrating a schematic configuration of communication devices and a communication system that perform serial transmission in parallel via four transmission cables (300, 302, 303, 304). In FIG. 5, the same components as those in FIG. 1 are designated by the same reference numerals, and differences will be mainly described below.

The communication system of FIG. 5 includes a SerDes device (200) and a SerDes device (400) connected to the plurality of transmission cables (300, 302, 303, 304). The SerDes device (200) includes a plurality of PHY blocks (200-1, 200-12, 200-13, 200-14) connected to the plurality of transmission cables (300, 302, 303, 304), a link block 200-2, a plurality of application stream encapsulators (200-3), a plurality of application stream de-encapsulators (200-4), a plurality of TDD timing counters (200-5, 200-6, 200-7, 200-8), and a link aggregator (200-10). The link aggregator (200-10) includes a de-multiplexer (200-10-1), a multiplexer (200-10-2), and a plurality of buffer memories (200-10-3).

The SerDes device (400) includes a plurality of PHY blocks (400-1, 400-12, 400-13, 400-14) connected to the plurality of transmission cables (300, 302, 303, 304), a link block 400-2, a plurality of application stream encapsulators (400-3), a plurality of application stream de-encapsulators (400-4), a TDD timing counter (400-5), and a link aggregator (400-10). The link aggregator (400-10) includes a de-multiplexer (400-10-1), a multiplexer (400-10-2), and a plurality of buffer memories (400-10-3).

The PHY blocks (200-12, 200-13, 200-14) each have the same configuration as the PHY block (200-1), which are connected to the corresponding transmission cables (300, 302, 303, 304). Similarly, the PHY blocks (400-12, 400-13, 400-14) each have the same configuration as the PHY block (400-1), which are connected to the corresponding transmission cables (300, 302, 303, 304). Four transmission cables (300, 302, 303, 304) will be described below by way of example, but any number of transmission cables (300, 302, 303, 304) may be used.

The TDD timing counters (200-5, 200-6, 200-7, 200-8) are connected to the PHY blocks (200-1, 200-12, 200-13, 200-14), respectively. Their operations are the same as that of the TDD timing counter (200-5) in FIG. 1 described above.

A frame-structured signal including a video signal from the link block (200-2) is input to the link aggregator (200-10). The input signal is supplied to the PHY blocks (200-1, 200-12, 200-13, 200-14) on a frame basis by the de-multiplexer (200-10-1). The processing in each PHY block (200-1, 200-12, 200-13, 200-14) is the same as the PHY block (200-1) in FIG. 1, and the processed signals are output to the transmission cables (300, 302, 303, 304) as down link signals #1, #2, #3, and #4, respectively.

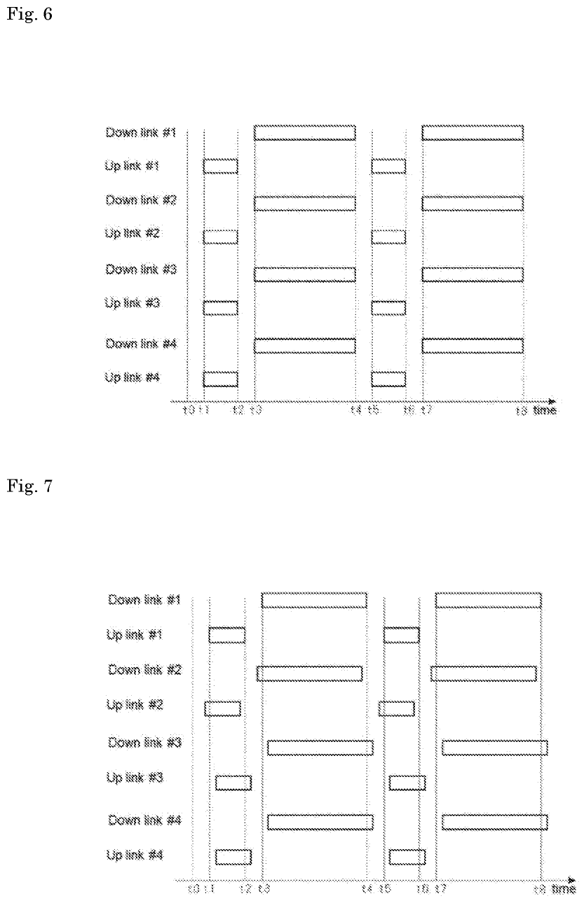

FIG. 6 is a timing chart of up link signals and down link signals, which are transmitted through the four transmission cables (300, 302, 303, 304). As illustrated in the figure, ideally, four up link signals are transmitted at the same timing, and similarly, four down link signals are transmitted at the same timing.

If the lengths of the transmission cables (300, 302, 303, 304) are not completely equal, their propagation delays are different. Therefore, as illustrated in FIG. 7, at the input ends of the PHY blocks (400-1, 400-12, 400-13, 400-14), the arrival times of the respective signals are shifted. This is generally called inter-lane skew.

Down link signals #1, #2, #3, and #4 are input to the PHY blocks (400-1, 400-12, 400-13, 400-14), subjected to the same processing as in the down link Rx (400-1-2) by the down link Rxs of the PHY blocks, respectively, and then output to the link aggregator (400-10).

The link aggregator (400-10) temporarily stores the signals from the PHY blocks (400-1, 400-12, 400-13, 400-14) in their respective buffer memories (400-10-3). Each buffer memory (400-10-3) compensates for the inter-lane skew illustrated in FIG. 7 by eliminating the time differences between the down link signals #1, #2, #3, and #4 to align the times of all the down link signals as illustrated in FIG. 6, and then the signals are output to the multiplexer (400-10-2). The multiplexer (400-10-2) performs reverse processing of the processing performed by the de-multiplexer (200-10-1) of the SerDes device (200), rearranges the frame signals in the order of the PHY blocks (400-1, 400-12, 400-13, 400-14), and outputs the resulting signals to the link block (400-2). The subsequent processing is the same as that in FIG. 1, and thus, the description thereof will be omitted. The signal flow of control signals such as I2C signals or GPIO signals from the SerDes device (400) to the SerDes device (200) is the same processing as the down link processing described above, in the same way as described in FIG. 1, and thus, the description thereof will be omitted.

The operation of switching between TDD signals on a plurality of lanes is performed by the TDD timing counter (400-5) and the TDD timing counters (200-5, 200-6, 200-7, 200-8) in the same way as described in FIG. 1, and the control signals of the respective TDD timing counters are output to the respective PHY blocks.

When TDD signals are transmitted using the plurality of lanes as illustrated in FIG. 5, the down link signals and the up link signals repeat ON/OFF all at once as illustrated in FIG. 6. In this case, the power supply may fluctuate significantly according to the ON/OFF of the signals. This can cause unnecessary radiation. Further, if the SerDes device includes analog processing, it can become a noise source and interfere with the analog processing.

In addition, unlike video signals, I2C signals or GPIO signals transmitted from the ECU (500) to the image sensor (100) through up link does not require a bandwidth that uses a plurality of lanes. Therefore, the PHY blocks (400-1, 400-12, 400-13, 400-14) will transmit only dummy signals as the up link outputs. In this case, even after scrambler processing, the same signal may be output from each PHY block, and if signals with the same phase are output on the plurality of lanes, it is expected to cause unnecessary radiation as described above. A communication device and a communication system according to the present disclosure described below are characterized in that unnecessary radiation can be prevented when signals are transmitted on a plurality of lanes.

### First Embodiment

A communication device and a communication system according to a first embodiment have the same block configuration as in FIG. 5. The SerDes devices (200, 400) in FIG. 5 each correspond to the communication device according to the first embodiment. Processing operations of the communication device and communication system according to the first embodiment will be described below with reference to FIG. 5.

In the first embodiment, the PHY blocks (200-1, 200-12, 200-13, 200-14) in the SerDes device (200) in FIG. 5 transmit down link signals on the plurality of lanes at staggered times to the plurality of transmission cables (300, 302, 303, 304). Similarly, the PHY blocks (400-1, 400-12, 400-13, 400-14) in the SerDes device (400) transmit up link signals on the plurality of lanes at staggered times to the plurality of transmission cables (300, 302, 303, 304). In other words, the PHY blocks (200-1, 200-12, 200-13, 200-14) transmit down link signals to the plurality of transmission cables (300, 302, 303, 304) at different timings, respectively, and receive a plurality of up link signals from the plurality of transmission cables (300, 302, 303, 304) at different timings, respectively. Similarly, the PHY blocks (400-1, 400-12, 400-13, 400-14) transmit up link signals to the plurality of transmission cables (300, 302, 303, 304) at different timings, respectively, and receive a plurality of down link signals from the plurality of transmission cables (300, 302, 303, 304) at different timings, respectively.

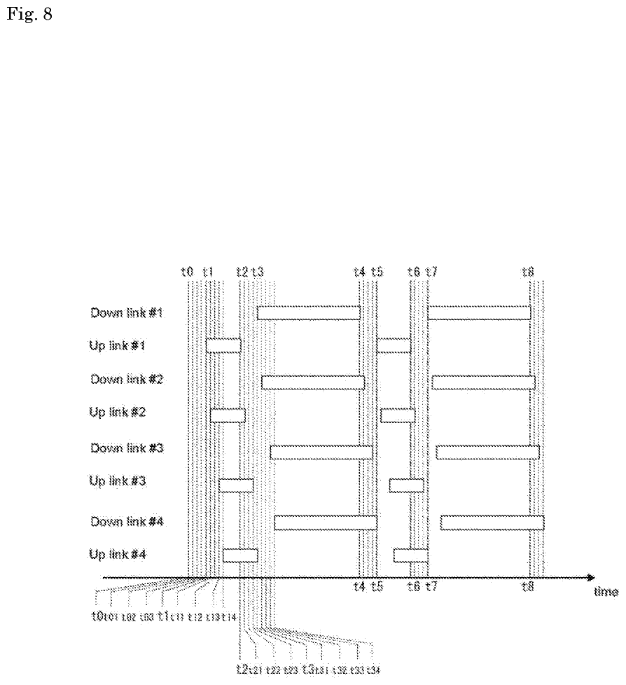

FIG. 8 is a diagram illustrating an example of the transmission timings of up link #1 to #4 signals and down link #1 to #4 signals, which are transmitted on four lanes corresponding to the four transmission cables (300, 302, 303, 304). Referring to FIG. 8, an example is described in which the up link #1 signal output from the up link Tx (400-1-1) of the PHY block (400-1) is first transmitted at time t1.

Times t0, t1, t2, . . . , t8 in FIG. 8 indicate the same times as those illustrated in FIGS. 2, 6, and 7. Times such as t01, t02, t03, t11, and t12 indicate four times into which the no-signal sections (t0 to t1) and (t2 to t3) are each divided.

The TDD timing counter (400-5) of the SerDes device (400) repeatedly counts one-TDD cycles from t0 to t4 (as a modulo counter for t4).

When the TDD timing counter (400-5) is at time t1, the TDD timing counter (400-5) controls the up link Tx (400-1-1) of the PHY block (400-1) to output up link #1. When the TDD timing counter (400-5) is at time t11, the TDD timing counter (400-5) controls the up link Tx (400-12-1) of the PHY block (400-12) to output up link #2. When the TDD timing counter (400-5) is at time t13, the TDD timing counter (400-5) controls the up link Tx (400-13-1) of the PHY block (400-13) to output up link #3. When the TDD timing counter (400-5) is at time t14, the TDD timing counter (400-5) controls the up link Tx (400-14-1) of the PHY block (400-14) to output up link #4.

When the TDD timing counter (400-5) is at time t2, the TDD timing counter (400-5) controls the up link Tx (400-1-1) of the PHY block (400-1) to stop up link #1. When the TDD timing counter (400-5) is at time t21, the TDD timing counter (400-5) controls the up link Tx (400-12-1) of the PHY block (400-12) to stop up link #2. When the TDD timing counter (400-5) is at time t23, the TDD timing counter (400-5) controls the up link Tx (400-13-1) of the PHY block (400-13) to stop up link #3. When the TDD timing counter (400-5) is at time t3, the TDD timing counter (400-5) controls the up link Tx (400-14-1) of the PHY block (400-14) to stop up link #4. These operations are repeated in a TDD cycle.

On the other hand, when the SerDes device (200) receives reception starting timing information of up link signals received at the PHY blocks (200-1, 200-12, 200-13, 200-14), which are connected to the TDD timing counter (200-5, 200-6, 200-7, 200-8), respectively, each TDD timing counter (200-5, 200-6, 200-7, 200-8) sets that receiving time as t1 and counts TDD cycles.

Each TDD timing counter (200-5, 200-6, 200-7, 200-8) controls the up link Rx (200-1-2) connected thereto to perform processing of receiving the up link signal until time t2. After that, the TDD timing counter (200-5, 200-6, 200-7, 200-8) controls the down link Tx (200-1-1) connected thereto to start output of the down link signal, outputs the down link signal during the time width of t3 to t5, and then stops the output.

Through the above operations, up link signals #1, #2, #3, and #4, which are output at staggered times, are received, and the respective down link signals are output based on the received signals, making it possible to output the down link signals at staggered times.

The times at which down link #1, #2, #3, #4 signals and up link #1, #2, #3, #4 signals are transmitted to the transmission cables (300, 302, 303, 304) may be staggered at equal intervals or at different intervals. For example, the PHY blocks (200-1, 200-12, 200-13, 200-14) sequentially transmit a plurality of down link signals to the plurality of transmission cables (300) at times that are staggered by a predetermined time difference. The predetermined time difference may be the same time difference, or may include two or more time differences with different time lengths.

As described above, in the communication device and communication system according to the first embodiment, for the transmission of up link signals and down link signals between the SerDes device (200) and the SerDes device (400) by using the TDD communication method, the up link signals on a plurality of lanes are transmitted at staggered times, respectively, and the down link signals on a plurality of lanes are transmitted at staggered times, respectively. Accordingly, the signal logic of the plurality of up link signals transmitted on the plurality of lanes does not change at the same timing, and similarly, the signal logic of the plurality of down link signals does not change at the same timing. As a result, it is possible to suppress EMI noise.

### Second Embodiment

Even in the case where the plurality of transmission cables (300, 302, 303, 304) connected between the SerDes device (200) and the SerDes device (400) are manufactured to have the same length as illustrated in FIG. 5, there is a possibility that a deviation in signal propagation delay time (PD) may occur due to manufacturing variations or the like. If the output delay time is determined without considering the transmission cable length, it is expected that the buffer memory (200-10-3) of the link aggregator (200-10, 400-10) overflows. In order to reduce the capacity of the buffer memory (200-10-3), the output timing of the PHY block connected to the transmission cable with small propagation delay can be delayed and the output timing of the PHY block connected to the transmission cable with large propagation delay can be made earlier.

Therefore, the communication device (SerDes (200, 400)) according to a second embodiment is characterized in that it measures signal propagation delay times of the plurality of transmission cables (300, 302, 303, 304).

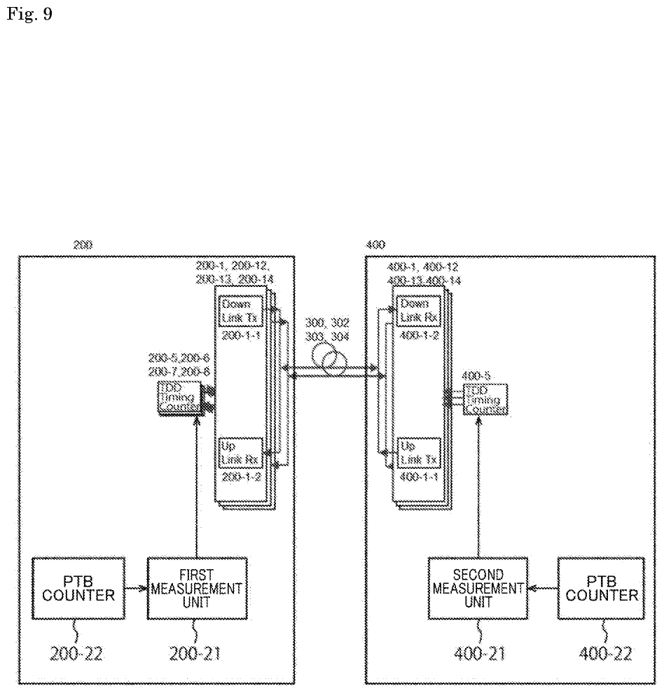

FIG. 9 is a block diagram illustrating part of an internal configuration of a SerDes (200) and a SerDes device (400) according to the second embodiment. The SerDes device (200) in FIG. 9 has the same internal configuration as the SerDes device (200) in FIG. 5, and also includes a first measurement unit 200-21. The first measurement unit 200-21 measures signal propagation delay times of a plurality of transmission cables (300, 302, 303, 304).

The PHY blocks (200-1, 200-12, 200-13, 200-14) in the SerDes device (200) adjust the timings of transmitting down link signals to be transmitted to the plurality of transmission cables (300, 302, 303, 304) based on measurement results of the first measurement unit 200-21. For example, the PHY blocks (200-1, 200-12, 200-13, 200-14) transmit, based on measurement results of the first measurement unit 200-21, to a cable with a longer signal propagation delay time of the plurality of cables (300, 302, 303, 304), the corresponding down link signal at an earlier timing. The measurement results of the first measurement unit 200-21 are input to the TDD timing counters (200-5, 200-6, 200-7, 200-8).

Similarly, the SerDes device (400) in FIG. 9 has the same internal configuration as the SerDes device (400) in FIG. 5, and also includes a second measurement unit 400-21. The second measurement unit 400-21 measures signal propagation delay times of the plurality of transmission cables (300, 302, 303, 304). The measurement results of the second measurement unit 400-21 are input to the TDD timing counter (400-5).

The PHY blocks (400-1, 400-12, 400-13, 400-14) in the SerDes device (400) adjust the timings of transmitting up link signals to be transmitted to the plurality of transmission cables (300, 302, 303, 304) based on measurement results of the second measurement unit 400-21. For example, the PHY blocks (400-1, 400-12, 400-13, 400-14) transmit, based on measurement results of the second measurement unit 400-21, to a cable with a longer signal propagation delay time of the plurality of cables (300, 302, 303, 304), the corresponding up link signal at an earlier timing.

The SerDes device (200) and the SerDes device (400) in FIG. 9 may have PTB counters 200-22 and 400-22. The PTB counters 200-22 and 400-22 each generate PTB timestamp information specified by the ASA standard. The ASA standard specifies that PTB timestamp information, which is common clock information, is transmitted between connected ASA devices. In the ASA, a means for obtaining propagation delay information between connected ASA devices is specified using the PTB timestamp information.

The SerDes device (200) and the SerDes device (400), which comply with the ASA standard, measure signal propagation delay times of the plurality of transmission cables (300, 302, 303, 304) in synchronization with the PTB time stamp information.

The PHY blocks (200-1, 200-12, 200-13, 200-14) in FIG. 9 acquire the signal propagation delay times of the plurality of transmission cables (300, 302, 303, 304) measured by the first measurement unit 200-21, and determine timings of outputting a plurality of down link signals. Similarly, the PHY blocks (400-1, 400-12, 400-13, 400-14) acquire the signal propagation delay times of the plurality of transmission cables (300, 302, 303, 304) measured by the second measurement unit 400-21, and determine timings of outputting a plurality of up link signals. For example, if the signal propagation delay times of the transmission cables (300, 302, 303, 304) increases in the order of the transmission cables (304), (300), (303), and (302), the four up link signals are output in order of up link #2, #3, #1, and #4.

Similarly, the TDD timing counters (200-5), (200-6), (200-7), and (200-8) of the SerDes device (200) can also use the propagation delay information based on the PTB timestamp information to adjust the timings of outputting the down link.

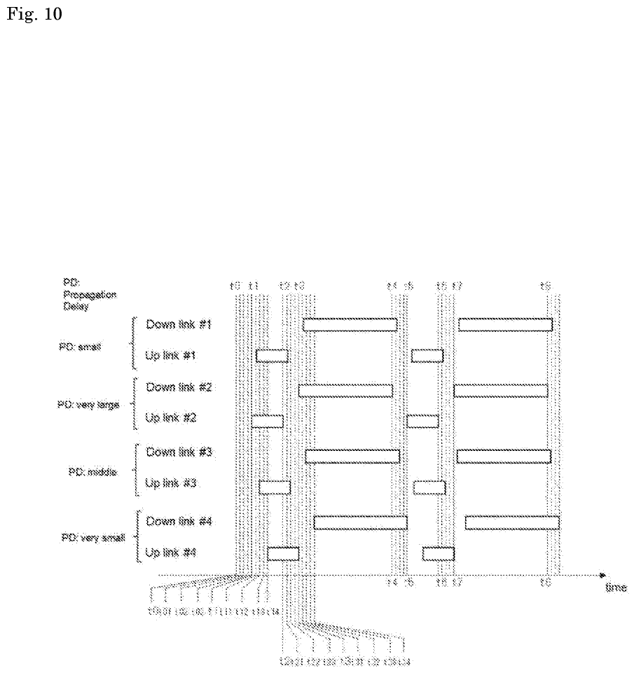

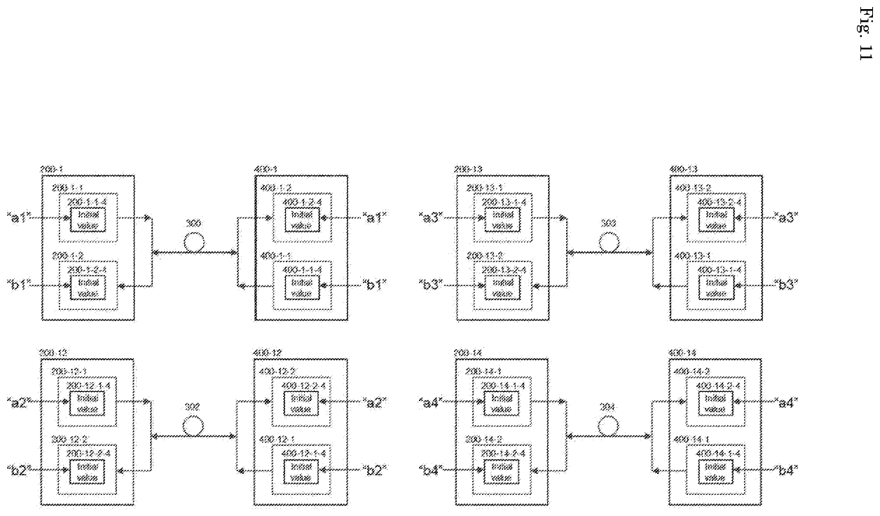

FIG. 10 is a timing chart illustrating an example of controlling the timings of down link signals output from the PHY blocks (200-1, 200-12, 200-13, 200-14) based on measurement results of the first measurement unit 200-21, and controlling the timings of up link signals output from the PHY blocks (400-1, 400-12, 400-13, 400-14) based on measurement results of the second measurement unit 400-21.

FIG. 10 illustrates an example in which the signal propagation delay times of the transmission cables (300, 302, 303, 304) increase in the order of the transmission cables (304), (303), (300), and (302). In this case, the PHY blocks (200-1, 200-12, 200-13, 200-14) output down link #2, #1, #3, and #4 signals in order, and the PHY blocks (400-1, 400-12, 400-13, 400-14) output up link #2, #1, #3, and #4 signals in order.

As described above, in the second embodiment, based on the measurement results of signal propagation delay times of the plurality of transmission cables (300, 302, 303, 304), the timings of outputting the four down link signals output from the PHY blocks (200-1, 200-12, 200-13, 200-14) are controlled, and the timings of outputting the four down link signals output from the PHY blocks (400-1, 400-12, 400-13, 400-14) are controlled, so that the storage capacities of the buffer memories (200-10-3, 400-10-3) for adjusting the signal propagation delay times can be reduced.

### Third Embodiment

In a third embodiment, initial values given to scramblers that cause a plurality of down link signals and a plurality of up link signals, which are transmitted on a plurality of lanes, to have a signal logic changing at a randomized timing, are different for each lane.

FIG. 11 is a diagram illustrating the connection relationships between the four PHY blocks (200-1, 200-12, 200-13, 200-14) in the SerDes device 200 and the four PHY blocks (400-1, 400-12, 400-13, 400-14) in the SerDes device 400, illustrated in FIG. 5. As illustrated, the PHY block (200-1) and the PHY block (400-1) are connected via the transmission cable (300). The PHY block (200-12) and the PHY block (400-12) are connected via the transmission cable (302). The PHY block (200-13) and the PHY block (400-13) are connected via the transmission cable (303). The PHY block (200-14) and the PHY block (400-14) are connected via the transmission cable (304).

The four PHY blocks (200-1, 200-12, 200-13, 200-14) in the SerDes devices 200 basically have the same internal configuration as the SerDes device (200) in FIG. 5. In addition, in the PHY blocks (200-1, 200-12, 200-13, 200-14) in FIG. 11, the four down link Txs (200-1-1, 200-12-1, 200-13-1, 200-14-1) include first initial value setting units (200-1-1-4, 200-12-1-4, 200-13-1-4, 200-14-1-4), respectively, and the four up link Rxs (200-1-2, 200-12-2, 200-13-2, 200-13-3) include second initial value setting units (200-1-2-4, 200-12-2-4, 200-13-2-4, 200-14-2-4), respectively.

The first initial value setting unit (200-1-1-4, 200-12-1-4, 200-13-1-4, 200-14-1-4) sets a different first initial value for each of the four down link signals. The second initial value setting unit (200-1-2-4, 200-12-2-4, 200-13-2-4, 200-14-2-4) sets a different second initial value for each of the four up link signals. The first initial value and the second initial value are given from a register or a controller (not illustrated).

Each of the four down link Txs (200-1-1, 200-12-1, 200-13-1, 200-14-1) includes a scrambler 200-1-1-1 having the same configuration as in FIG. 4. Each scrambler 200-1-1-1 generates a first pseudo-random number based on the corresponding first initial value, and performs a logical operation between the corresponding down link signal and the first pseudo-random number to generate a corresponding down link signal.

More specifically, the scrambler 200-1-1-1 included in each of the down link Txs (200-1-1, 200-12-1, 200-13-1, 200-14-1) includes the first initial value setting unit (200-1-1-4, 200-12-1-4, 200-13-1-4, 200-14-1-4) illustrated in FIG. 11, the first random number generation unit (pseudo-random number pattern generator (200-1-1-1a)) illustrated in FIG. 4, and the first logical operation unit (XOR operator (200-1-1-1b)) illustrated in FIG. 4. The first random number generation unit (200-1-1-1a) generates a first pseudo-random number based on the first initial value. The first logical operation unit (200-1-1-1b) performs a logical operation between the corresponding transmission signal and the corresponding first pseudo-random number to generate a corresponding down link signal (first signal).

Similarly, each of the four up link Rxs (400-1-1, 400-12-1, 400-13-1, 400-14-1) includes a de-scrambler 200-1-2-1 having the same configuration as in FIG. 4. Each de-scrambler 200-1-2-1 generates a second pseudo-random number based on the corresponding second initial value, and performs a logical operation between the corresponding up link signal and the second pseudo-random number to generate the original transmission signal.

More specifically, the de-scrambler 200-1-2-1 included in each of the up link Rxs (400-1-1, 400-12-1, 400-13-1, 400-14-1) includes the second initial value setting unit (200-1-2-4, 200-12-2-4, 200-13-2-4, 200-14-2-4) illustrated in FIG. 11, the second random number generation unit (pseudo-random number pattern generator (200-1-1-1a)) illustrated in FIG. 4, and the second logical operation unit (XOR operator (200-1-1-1b)) illustrated in FIG. 4. The second random number generation unit (200-1-1-1a) generates a second pseudo-random number based on the second initial value. The second logical operation unit (200-1-1-1b) performs a logical operation between the corresponding up link signal and the corresponding second pseudo-random number to restore to the corresponding original transmission signal.

The down link Tx (200-1-1, 200-12-1, 200-13-1, 200-14-1) and the down link Rx (400-1-2, 400-12-2, 400-13-2, 400-14-2), which make a pair, are set with the same initial value. However, different down link Txs are set with different initial values. For example, the initial value in the initial value register (200-1-1-4) of the down link Tx (200-1-1) of the PHY block (200-1) and the initial value in the initial value register (400-1-2-4) of the down link Rx (400-1-2) of the PHY block (400-1) that makes the same pair are the same with “al”. On the other hand, the initial value in the initial value register (200-1-14-4) of the down link Tx (200-14-1) of the PHY block (200-14) and the initial value in the initial value register (400-14-2-4) of the down link Rx (400-14-2) of the PHY block (400-14) are “a4”, which is a different initial value.

Similarly, the scrambler of the up link Tx (400-1-1, 400-12-1, 400-13-1, 400-14-1) and the de-scrambler of the up link Rx (200-1-2, 200-12-2, 200-13-2, 200-14-2), which make a pair, are set with the same initial value. On the other hand, the initial values of the scrambler of the up link Tx and the de-scrambler of the up link Rx, which makes another pair, are a different value.

As described above, in the third embodiment, by changing the initial values of the scrambler and the de-scrambler for each of the pairs of the down link Txs (200-1-1, 200-12-1, 200-13-1, 200-14-1) and the down link Rxs (400-1-2, 400-12-2, 400-13-2, 400-14-2) and for each of the pairs of the up link Txs (400-1-1, 400-12-1, 400-13-1, 400-14-1) and the up link Rxs (200-1-2, 200-12-2, 200-13-2, 200-14-2), even when signals are transmitted at the same timing on the plurality of lanes and signals are received at the same timing on the plurality of lanes, the patterns of the signals do not become the same, making it possible to contribute to EMI reduction.

The present technology can have the following configurations.

(1) A communication device, including a plurality of communication units that, by a time division duplex (TDD) communication method, transmit a plurality of first signals at staggered times to a plurality of cables, respectively, and receive a plurality of second signals at staggered times by the plurality of cables, respectively.

(2) The communication device according to (1), wherein the plurality of communication units transmit the plurality of first signals to the plurality of cables at different timings, respectively, and receive the plurality of second signals from the plurality of cables at different timings, respectively.

(3) The communication device according to (1) or (2), wherein each of the plurality of communication units transmits the corresponding first signal in a first signal section, and receives the corresponding second signal in a second signal section, by using the corresponding cable.

(4) The communication device according to any one of (1) to (3), wherein the plurality of communication units sequentially transmit the plurality of first signals so as to be staggered by predetermined time differences to the plurality of cables.

(5) The communication device according to (4), wherein the predetermined time differences are equal.

(6) The communication device according to (4), wherein the predetermined time differences include two or more time differences having different time lengths.

(7) The communication device according to any one of (1) to (6), including a plurality of temporary storage units that adjust variations in timings of receiving the plurality of second signals received by the plurality of communication units.

(8) The communication device according to (7), wherein each of the plurality of temporary storage units has a storage capacity that varies depending on a signal propagation delay time of the corresponding cable.

(9) The communication device according to (7) or (8), wherein the plurality of temporary storage units adjust variations in a plurality of the signal propagation delay times of the plurality of cables.

(10) The communication device according to any one of (1) to (9), including a measurement unit that measures signal propagation delay times of the plurality of cables, wherein the plurality of communication units adjust, based on measurement results of the measurement unit, timings of transmitting the plurality of first signals to be transmitted to the plurality of cables.

(11) The communication device according to (10), including a precision time base (PTB) counter that generates time stamp information commonly used with a communication partner device, wherein the measurement unit measures signal propagation delay times of the plurality of cables in synchronization with the time stamp information.

(12) The communication device according to (10) or (11), wherein the plurality of communication units transmit, based on measurement results of the measurement unit, to a cable with a longer signal propagation delay time of the plurality of cables, the corresponding first signal at an earlier timing.

(13) A communication device, including a plurality of communication units that, by a time division duplex (TDD) communication method, transmit a plurality of first signals to a plurality of cables and receive a plurality of second signals by the plurality of cables,
wherein the plurality of communication units include a plurality of scramblers that generate the plurality of first signals in which a plurality of transmission signals each have a logic changing at a randomized timing, and
each of the plurality of scramblers includes
a first initial value setting unit that sets a different first initial value for each of the first signals,
a first random number generation unit that generates a first pseudo-random number based on the first initial value, and
a first logical operation unit that generates the corresponding first signal by performing a logical operation between the corresponding transmission signal and the corresponding first pseudo-random number.

(14) The communication device according to (13), wherein the first initial value setting unit sets the first initial value that is same as an initial value used by a communication partner device that receives the corresponding first signal to restore an original transmission signal.

(15) The communication device according to (13) or (14), wherein the plurality of communication units include a plurality of de-scramblers that perform decoding processing on the plurality of second signals, and
each of the plurality of de-scramblers includes
a second initial value setting unit that sets a different second initial value for each of the second signals,
a second random number generation unit that generates a second pseudo-random number based on the second initial value, and
a second logical operation unit that generates a corresponding reception signal by performing a logical operation between the corresponding second signal and the corresponding second pseudo-random number.

(16) The communication device according to (15), wherein the second initial value setting unit sets the second initial value that is same as an initial value used by a communication partner device that transmits the corresponding second signal to generate the second signal.

(17) A communication system, including:
a first communication device; and
a second communication device, the second communication device and the first communication device alternately transmitting and receiving information within a period allocated by a time division duplex (TDD) communication method,
wherein each of the first communication device and the second communication device includes
a plurality of communication units that transmit a plurality of first signals at staggered times to a plurality of cables, respectively, and receive a plurality of second signals at staggered times by the plurality of cables, respectively.

Aspects of the present disclosure are not limited to the aforementioned individual embodiments and include various modifications that those skilled in the art can achieve, and effects of the present disclosure are also not limited to the details described above. In other words, various additions, modifications, and partial deletion can be made without departing from the conceptual idea and the scope and spirit of the present disclosure that can be derived from the details defined in the claims and the equivalents thereof.

### REFERENCE SIGNS LIST

100 Image sensor
200 Device
200-1, 200-12, 200-13, 200-14 SerDes device
200-10 Aggregator
200-10-1 De-multiplexer
200-10-2 Multiplexer
200-10-3 Buffer memory
200-1-1 Down link Tx
200-1-1-1 Scrambler
200-1-1-1a Pseudo-random pattern generator
200-1-1-1b Operator
200-1-1-2 Mapper
200-1-1-3 Driver
200-1-1-4 Initial value register
200-1-14-4 Initial value register
200-1-2 Up link Rx
200-1-2-1 De-scrambler
200-1-2-3 Receiver
200-14-1 Down link Tx
200-2 Link block
200-21 First measurement unit
200-2-1 Frame constructor
200-22 PTB counter
200-3 Application stream encapsulator
200-4 Application stream de-encapsulator
200-5, 200-6, 200-7, 200-8 Timing counter
300, 302, 303, 304 Transmission cable
400-1, 400-12, 400-13, 400-14 SerDes device
400-10 Aggregator
400-10-1 De-multiplexer
400-10-2 Multiplexer
400-10-3 Buffer memory
400-1-1 Up link Tx
400-1-1-1 Scrambler
400-1-1-3 Driver
400-1-2 Down link Rx
400-12-1 Up link Tx
400-1-2-1 De-scrambler
400-1-2-2 De-mapper
400-1-2-3 Receiver
400-1-2-4 Initial value register
400-13-1 Up link Tx
400-14-1 Up link Tx
400-14-2 Down link Rx
400-14-2-4 Initial value register
400-2 Link block
400-21 Second measurement unit
400-2-1 Frame constructor
400-2-2 Frame de-constructor
400-3 Application stream encapsulator
400-4 Application stream de-capsulator
400-4 Application stream de-encapsulator
400-5 Timing counter

1. A communication device, comprising a plurality of communication units that, by a time division duplex (TDD) communication method, transmit a plurality of first signals at staggered times to a plurality of cables, respectively, and receive a plurality of second signals at staggered times by the plurality of cables, respectively.

2. The communication device according to claim 1, wherein the plurality of communication units transmit the plurality of first signals to the plurality of cables at different timings, respectively, and receive the plurality of second signals from the plurality of cables at different timings, respectively.

3. The communication device according to claim 1, wherein each of the plurality of communication units transmits the corresponding first signal in a first signal section, and receives the corresponding second signal in a second signal section, by using the corresponding cable.

4. The communication device according to claim 1, wherein the plurality of communication units sequentially transmit the plurality of first signals so as to be staggered by predetermined time differences to the plurality of cables.

5. The communication device according to claim 4, wherein the predetermined time differences are equal.

6. The communication device according to claim 4, wherein the predetermined time differences include two or more time differences having different time lengths.

7. The communication device according to claim 1, comprising a plurality of temporary storage units that adjust variations in timings of receiving the plurality of second signals received by the plurality of communication units.

8. The communication device according to claim 7, wherein each of the plurality of temporary storage units has a storage capacity that varies depending on a signal propagation delay time of the corresponding cable.

9. The communication device according to claim 7, wherein the plurality of temporary storage units adjust variations in a plurality of the signal propagation delay times of the plurality of cables.

10. The communication device according claim 1, comprising a measurement unit that measures signal propagation delay times of the plurality of cables, wherein the plurality of communication units adjust, based on measurement results of the measurement unit, timings of transmitting the plurality of first signals to be transmitted to the plurality of cables.

11. The communication device according to claim 10, comprising a precision time base (PTB) counter that generates time stamp information commonly used with a communication partner device,
wherein the measurement unit measures signal propagation delay times of the plurality of cables in synchronization with the time stamp information.

12. The communication device according to claim 10, wherein the plurality of communication units transmit, based on measurement results of the measurement unit, to a cable with a longer signal propagation delay time of the plurality of cables, the corresponding first signal at an earlier timing.

13. A communication device, comprising a plurality of communication units that, by a time division duplex (TDD) communication method, transmit a plurality of first signals to a plurality of cables and receive a plurality of second signals by the plurality of cables,
wherein the plurality of communication units include a plurality of scramblers that generate the plurality of first signals in which a plurality of transmission signals each have a logic changing at a randomized timing, and
each of the plurality of scramblers includes a first initial value setting unit that sets a different first initial value for each of the first signals,
a first random number generation unit that generates a first pseudo-random number based on the first initial value, and
a first logical operation unit that generates the corresponding first signal by performing a logical operation between the corresponding transmission signal and the corresponding first pseudo-random number.

14. The communication device according to claim 13, wherein the first initial value setting unit sets the first initial value that is same as an initial value used by a communication partner device that receives the corresponding first signal to restore an original transmission signal.

15. The communication device according to claim 13, wherein
the plurality of communication units include a plurality of de-scramblers that perform decoding processing on the plurality of second signals, and
each of the plurality of de-scramblers includes
a second initial value setting unit that sets a different second initial value for each of the second signals,
a second random number generation unit that generates a second pseudo-random number based on the second initial value, and
a second logical operation unit that generates a corresponding reception signal by performing a logical operation between the corresponding second signal and the corresponding second pseudo-random number.

16. The communication device according to claim 15, wherein the second initial value setting unit sets the second initial value that is same as an initial value used by a communication partner device that transmits the corresponding second signal to generate the second signal.

17. A communication system, comprising:
a first communication device; and
a second communication device, the second communication device and the first communication device alternately transmitting and receiving information within a period allocated by a time division duplex (TDD) communication method,
wherein each of the first communication device and the second communication device includes
a plurality of communication units that transmit a plurality of first signals at staggered times to a plurality of cables, respectively, and receive a plurality of second signals at staggered times by the plurality of cables, respectively.
